(19) United States
(12) Patent Application Publication
(10) Pub. No.: US 2004/0178921 A1
(43) Pub. Date: Sep. 16, 2004

(54) Intruder alarm

(76) Inventor: Malcolm G Lawrence, Essex (GB)

Correspondence Address: Howison & Arnott, P O Box 741715, Dallas, TX, 75374-1715, US

(21) Appl. No.: 10/399,721

(22) PCT Filed: Mar. 7, 2001
(86) PCT No.: PCT/GB01/00975

(30) Foreign Application Priority Data
Mar. 7, 2000 (GB) 0005497.3

(51) Int. Cl. G08B 3/00

(52) U.S. Cl. 340/691.1; 340/541

(57) ABSTRACT

An alarm system comprises plural movement PIR detector of which three such detectors are shown and designated by reference numerals (1, 2 and 3). An alarm control box (4) is connected to the movement detectors (1, 2 and 3) so as to receive an activation signal from a movement detector which has been actuated by movement from an intruder within its range. Control box (4) is connected to an illumination controller (5) provided to energise lamps (6, 7, 8 and 9) intermittently once an alarm activation signal has been received by control box (4). Controller (5) is equipped to alternate the illumination of a lamp (6, 7, 8, 9) so that, upon receipt of a signal from control box (4) designated for the energisation of a particular lamp, the lamp is first energised so as to illuminate it to a level which causes closure of the irises of the eyes of the intruder (but without permanent eye damage) and then de-energised so that illumination is near zero for sufficient time for iris recovery (e.g. a period of 6 seconds). Thereafter, the same lamp (or another lamp in response to detection of the intruder by another of the movement detectors) is illuminated (again) so as to close intruder's irises. In this way, the intruder's eyes are unable to acclimatise to the changing light conditions and his movement about the space addressed by the alarm system is seriously imparied.

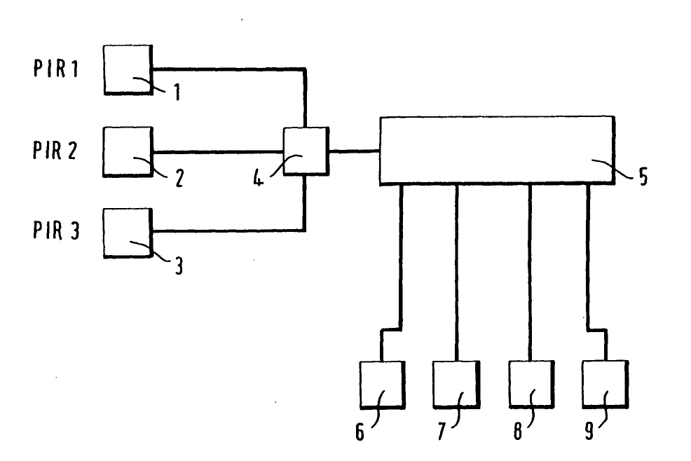

The invention relates to intruder alarms.

Intruder alarms operate by detecting the presence of an intruder in an environment, by means such as a point alarm actuated by door or window opening or a PIR detector, and reacting to such detection by actuating an audible alarm. Some alarm systems provide for a visual alarm using the external lights of a building or automobile. Modern building intruder alarms are connected to the public telephone network and transmit an alarm signal via that network to processing station for onward alert of either police or private security personnel.

Systems which alert police are generally regarded as the most desirable since intruders are not wholly deterred by mere local alarm output. Police response time is, however, non-immediate with the result that an intruder in an unoccupied building has finite time to remove objects of most value, and escape the premises without apprehension by police.

Tactics are practised which impede the conduct of such an intruder whilst in the building. For example, doors can be locked and in this way progress of the intruder through the building is slowed and there is reduced opportunity for selective removal of objects of value. Intruder systems are known in which alarm detector actuation causes infrastructural systems of a building such as its lighting system to operate so as to simulate occupation of the building and so deter any intruder present.

The present invention provides an intruder alarm system, for example for an enclosed or other space, for example a vehicle or a building (eg an office building), addressed by intruder detection means of the system, wherein intruder detection means of the system is arranged to actuate, in response to intruder detection by said intruder detection means, illumination system control means for an illumination system addressed to at least part of the space whereby said illumination system provides alternating illumination in the form of intermittent illumination or illumination of alternation intensity to the space or to one or more individuals sub-spaces therein.

The objective of the alternation is to impair intruder visual acuity by exploiting the lag in the response time of the ocular iris to changing light conditions.

By means of the invention, the illumination of any particular sub-space or that of the space as a whole may be alternated between an illuminated condition (eg the illumination system addressed thereto is fully illuminated to its normal illumination intensity state or is illuminated to a preferably temporary state of super normal illumination intensity) and a condition in Which said sub-space or space is non-illuminated or illuminated to a state of illumination intensity which is sub normal and preferably sufficiently low as to have only a minor effect in terms of iris closure stimulus on a normal unprotected eye.

In a particular one of its embodiments, the present invention provides an intruder alarm system, for example for an enclosed or other space, for example a vehicle or a building (eg an office building), addressed by intruder detection means of the system, wherein intruder detection means of the system is arranged to actuate, in response to intruder detection by said intruder detection means, a controller for the supply to at least part of an illumination system, in particular the or part of an internal space lighting system, of electrical power, characterised in that said controller is arranged so as in use upon actuation by said intruder detection means to supply electrical power to at least part of said illumination system intermittently (ie to supply said power in alternating phases of supply separated by non-supply periods or periods during which supply is substantially reduced) whereby said lighting system alternates between a condition in which at least part thereof is illuminated (eg fully illuminated to its normal illumination intensity state or illuminated to a preferably temporary state of super normal illumination intensity) and a condition in which at least said part is non-illuminated or illuminated to a state of illumination intensity which is sub normal and preferably sufficiently low as to have only a minor effect in terms of iris closure stimulus on a normal unprotected eye.

Preferably, an intruder detection means of a subset plurality of such detection means scans a part of a building and an illumination system for that part is in use alternated eg between energised and non-energised conditions, by a controller respective to that part of the building and arranged for actuation by said intruder detection means.

Of course, as already inferred, alternation as referred to above may be alternation between first and second illuminated states wherein the first illuminated state is relatively highly illuminated and the second is relatively less illuminated (if not essentially non-illuminated). In practice, the difference in illumination x-ill be sufficient that each first illuminated state will cause impaired intruder visual acuity for a significant period of time in which the second illuminated state persists.

Conveniently, the controller provides for a predetermined or pre-selected number of cycles of illumination alternation for each intruder detection means actuation of the controller.

It is not necessary that each cycle of alternation be the same in terns of any one or more of cycle time, illumination time or illumination degree differential between conditions of illumination and relative non-illumination.

Preferably, the illumination system referred to above is the space lighting system of the building or vehicle infrastructure or other space scanned or otherwise addressed by the intruder detection means of the detection system. For proper interface with the intruder system of the invention, the space lighting system is wired so it may be energised by the controller, for example by actuation of a relay controlling the space lighting system or a part thereof.

Alternatively, the illumination system referred to may be an intruder-repulsive secondary system which may be purpose-provided (and which may, however, be controlled so that it may be deployed for other purposes eg when higher levels of illumination are required that ordinarily offered by the space lighting system) or may be an emergency lighting system having a normal emergency illumination mode (in which ordinarily the state of illumination is one of subdued illumination powered by a battery or other secondary electrical power system) and an intruder-repulsive illumination mode.

Intruder alarm systems according to the invention in which the controller addresses an emergency lighting system having a normal emergency illumination mode and an intruder-repulsive illumination mode are preferred according to the invention.

An intruder-repulsive secondary system may comprise one or more arrays of flashlight means, for example at least one flashlight means or sub-array of plural such flashlight means for each of at least some, and preferably all, of the sub-spaces in the space addressed by the alarm system. A room in an office building, for example, may be provided with a flashlight means comprising one or a sub-array or plural such means, such flashlight or sub-array normally forming part of an overall array of flashlights addressed to the overall space addressed by the intruder detection means of the intruder alarm system. Such flashlight means may be any eg lamp which illuminates to high intensity with little rise time but flashlight in the sense meant herein includes illumination means giving illumination of alternating directionality so as to achieve an analogous effect in practice, the alternating directionality enabling the illumination to sweep the space.

In one embodiment of the invention, the controller addresses an illumination system comprising directionally rotating elements and on actuation energises said system and causes rotational displacement of said elements. Such rotational displacement of said elements may be in the form of displacement of uniform angular velocity (although non-uniform angular velocity may be provided for) and in general practice the control means will direct all or substantially all the elements scanning a particular sub-space to scan it substantially simultaneously.

Preferred systems according to the invention include sound output means localised to at least one eg to each element of a multiple element illumination system addressed by the control means, the control means causing said sound output means to output a sound a short time before directing said element to illuminate a sub-space to which it is addressed (eg 0.25 seconds before hand). It is known that the sub-conscious reaction of a naive human subject is to direct himself to the apparent source of a sound output on hearing the sound, and thus, by localising to illumination elements a sound output means, it is possible to maximum the iris closure effects of the illumination system by causing an intruder to look directly at the locus of an intruder-repulsive light discharge. The sound output means may be arranged to output a broad band sound signal directionally resolvable accurately by the brain, usually in combination with a relatively narrow band alert signal designed to attract the attention of the intruder.

An embodiment of the invention will now be described by way of example, reference being made to the accompanying drawing which shows interface of an alarm system with a building lighting system.

The alarm system shown in the drawing comprises plural movement detectors (eg PIR detectors) of which three such detectors are shown and designated by reference numerals 1, 2 and 3.

An alarm control box 4 is connected to the movement detectors 1, 2 and 3 so as to receive an activation signal from a movement detector which has been actuated by movement from an intruder within its range. Control box 4 is also connected to a siren or other audible alarm (not shown) which is energised upon receiving a movement detector signal.

Control box 4 is also connected to the public telephone network, usually via a controller, so as to deliver a signal to a central monitoring station (not shown) responsible for monitoring activation of the alarm system.

Control box 4 is connected to an illumination controller 5 provided to energise lamps 6, 7, 8 and 9 intermittently once an alarm activation signal has been received by control box 4. Controller 5 is provided with relays respective to each lamp 6, 7, 8 and 9, receipt by controller 5 of an alarm activation signal from control box 4 is accompanied by attributes which identify, which movement detector has been activated. Such signal is received by controller 5 so as to activate the appropriate relay thereof for supply of power to such one of lamps 6, 7, 8 and 9 as is associated with the movement detector which has been activated whereby there is coordination between lamp and movement detector with the result that illumination is addressed to the part of the space addressed by the alarm system which space is associated with the intruder.

Controller 5 is equipped to alternate the illumination of a lamp 6, 7, 8 and 9 so that, upon receipt of a signal from control box 4 designated for the energisation of a particular lamp, the lamp is first energised so as to illuminate it to a level which causes closure of the irises of the eyes of the intruder (but without permanent eye damage) and then de-energised so that illumination is near zero for sufficient time for iris recovery (eg a period of 6 seconds). Thereafter, the same lamp (or another lamp in response to detection of the intruder by another of the movement detectors) is illuminated (again) so as to close the intruder's irises. In this way, the intruder's eves are unable to acclimatise to the changing light conditions and his movement about the space addressed by the alarm system is seriously impaired.

Apparatus for providing intermittent illumination within a building in response to intruder detection is described in detail in U.S. Pat. No. 4,642,477, that apparatus may be adopted, with suitable modification where necessary, in order to provide intruder alarm-actuated intermittent illumination for the purpose of the present invention: in this connection, it will be appreciated that the purpose of the present invention is to provide such illumination for impeding the vision of an intruder within an enclosure into which he has intruded rather than for the purpose of alerting persons to the fact of an intrusion by visual rather than solely audible means.

1. Use of intermittent illumination apparatus for impeding the vision of an intruder within an enclosure into which he has intruded, the apparatus comprising intruder detection means disposed within said enclosure and there arranged to actuate the apparatus in response to intruder detection, said apparatus being disposed to illuminate the space within the enclosure by intermittent illumination or illumination of alternating intensity.

2. An anti-intruder device for impeding the vision of an intruder within an enclosure into which he has intruded, the device comprising intruder detection means to be disposed within said enclosure and there arranged to actuate intermittent illumination means of the device disposed to illuminate the space within the enclosure, said illumination means including control means for providing intermittency of the illumination.

3. An intruder alarm system for example for an enclosed or other space addressed by intruder detection means of the system, wherein said intruder detection means of the system is arranged to actuate, in response to intruder detection by said intruder detection means, illumination system control means for an illumination system addressed to at least a part of the space whereby said illumination system provides alternating illumination in the form of intermittent illumination or illumination of alternating intensity to the space or to one or more individual sub-spaces therein.

4. An intruder alarm system for an enclosed or other space addressed by intruder detection means of the system wherein intruder detection means of the system is arranged to actuate, in response to intruder detection by said intruder detection means, a controller for the supply to at least part of an illumination system, or part of an internal space lighting system, of electrical power, characterised in that said controller is arranged so as in use upon actuation by said intruder detection means to supply electrical power to at least part of said illumination systems intermittently whereby said lighting system alternates between a condition in which at least part thereof is illuminated and a condition in which at least said part is non-illuminated or illuminated to a state of illumination intensity which is sub normal and preferably sufficiently low as to have only a minor effect in terms of iris closure stimulus on a normal unprotected eye.
